(19) United States
(12) Patent Application Publication
(10) Pub. No.: US 2011/0147372 A1
(43) Pub. Date: Jun. 23, 2011

(54) Cooking Table

(75) Inventor: Antoine Lebrun, Pornichet (FR)

(73) Assignee: Aktiebolaget Electrolux, Stockholm (SE)

(21) Appl. No.: 12/978,517

(22) Filed: Dec. 24, 2010

Related U.S. Application Data
(63) Continuation-in-part of application No. PCT/SE2009/000323, filed on Jun. 23, 2009.

(30) Foreign Application Priority Data
Jun. 24, 2008 (SE) 0801.488-8

(51) Int. Cl. F24C 7/10; H05B 6/12; H01B 1/00

(52) U.S. Cl. 219/622; 126/276; 126/9 B; 219/453.11; 219/459.1

(57) ABSTRACT

A mobile cooking table. The mobile cooking table has a table top including an induction hob and a cutting board. In addition to cooking elements, the table top has a warming area for keeping food at the correct temperature after cooking. The cooking table has legs with wheels providing the cooking table with mobility. The legs are power extendible enabling the height of the table top to be vertically adjusted. The mobile cooking table also includes a power connection which is preferably coupled to a wheel. The power connection can include a magnetic coupling. The mobile cooking table also includes a removable cutting board or tray forming a part of the table top. The adaptability and features of the mobile cooking table makes it a beneficial appliance for the interior environment.

### CROSS REFERENCE TO RELATED APPLICATION

This application is a continuation-in-part of International Application No. PCT/SE2009/000323 filed Jun. 23, 2009 entitled COOKING TABLE, which claims priority from Swedish Application No. 0801.488-8 filed Jun. 24, 2008 entitled COOKING TABLE, the entire contents of both are incorporated herein by reference.

### FIELD and BACKGROUND

The disclosure relates to a mobile cooking table. Today many young people are living an active life and have somewhat of nomad lifestyle. They commonly perform multiple tasks simultaneously and are socially connected. They do not have high end equipment in there kitchen, and are commonly living in small apartments. They are often single or living alone. They commonly do not have any set schedule at home but are also surrounded by technological gadgets. This commonly results in them eating alone and or with a small number of friends but while watching TV or using the Internet. However, many of them also prefer good quality but simple meals, using basic accessories, and with quick preparation. An adaptive cooking appliance to assist them under these lifestyle conditions would be beneficial.

### BRIEF SUMMARY

Aspects of the disclosure pertain to a mobile cooking table having an induction hob and a plurality of wheels for enabling the mobile cooking table to be rolled on a supporting surface.

According to another aspect, a mobile cooking table includes a cooking device having a substantially planar cooking surface and a frame with a plurality of wheels. A power coupling is located on at least one of the wheels. The power coupling, when connected, serves to lock at least one of the wheels.

According to another aspect, a mobile cooking table includes a table top, a frame having telescopic legs with wheels at their bottom ends and a magnetic power coupling coupled to at one wheel. The table top includes an induction hob and a removable cutting board or a removable tray.

### BRIEF DESCRIPTION OF THE DRAWINGS

The foregoing summary as well as the following detailed description, considered in conjunction with the accompanying drawings, provide a better understanding, in which like reference numbers refer to like elements, and wherein:

FIG. 1 is a perspective view of a cooking table according to an embodiment of the disclosure;

FIG. 2 is a perspective view of the table top of the cooking table in isolation;

FIG. 3 is a top view of the table top;

FIG. 4 is a exploded perspective view of the cooking table showing the removable cutting board in a removed state;

FIGS. 5 and 6 are perspective view and side views, respectively, of the cooking table illustrating its height adjustable capabilities;

FIG. 7 is a schematic side view of a leg of the cooking table;

FIG. 8 is a perspective view of a detail of the underside of the table top showing a user operable switch for controlling height adjustment;

FIG. 9 is a perspective view of a wheel and the power plug with prongs;

FIG. 10 is a perspective view of the plug coupled to the wheel.

### DETAILED DESCRIPTION

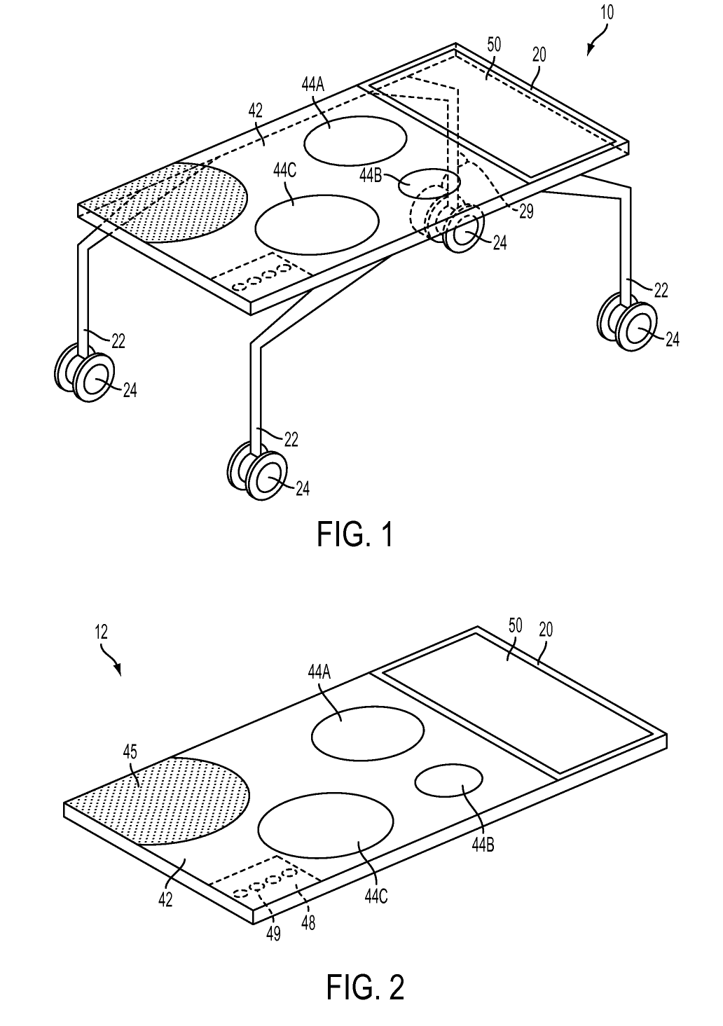

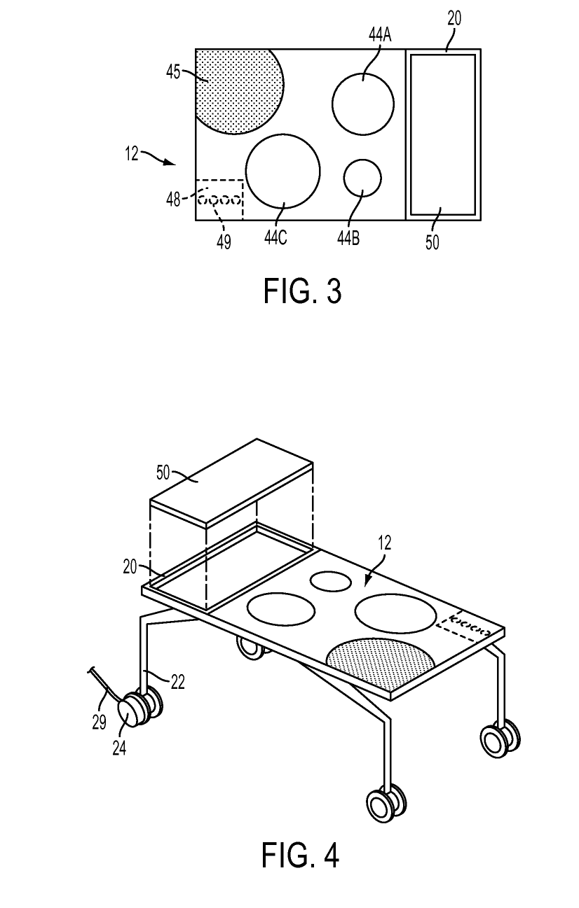

FIGS. 1-10 illustrate details of a cooking table 10 according to an embodiment of the disclosure. The cooking table 10 is in essence a mobile cooking station. According to the depicted embodiment, the cooking table 10 includes a table top 12 supported by a suitable supporting base including a plurality of legs 22. In one arrangement, the base, including the legs 22, is made of aluminum for lightness and strength. As can be seen in the figures, the bottom of the legs 22 include wheels 24 to enable the cooking table 10 to be wheeled to suitable locations for cooking, eating, and/or storage. Electric power is delivered to the cooking table 10 via power cord 29 for cooking and for height adjustment as is described hereinafter.

As shown in FIGS. 1-3, the table top 12 may be substantially planar. One part of the table top 12 includes a cooking device. The cooking device is preferably an HOB 42 and may be made from a glass ceramic surface for easy cleaning. In one embodiment, the HOB 42 is an induction HOB with three cooking zones 44a, 44b, and 44c. The induction system is beneficial because it is a low-energy consumption system. Additionally, it minimizes heat retained on the surface which is beneficial should the user want to utilize the cooking table 10 for a surface for dining or serving shortly after cooking. However, alternative cooking devices may be used in lieu of the induction system.

The table top 12 also includes a food warming zone 45 at the corner edge of the surface. This can be used to keep food at the right temperature after cooking. This warming zone 45 may be created by any low heat emitting device. For example, it could be formed by an electric heating system or it can be part of the induction based system.

The table top 12 also includes a control interface region 48 with smart touch sensitive controls 49. The controls 49 can be configured in any desirable arrangement to control the cooking areas 44a, 44b, and 44c and the warming zone 45. It is recognized that the controls 49 may be mapped within the region 48 to correspond to the configuration of the heating elements 44a, 44b, 44c, and 45 with respect to each other. The controls 49 may also be labeled with suitable indicia associating the controls 49 with the heating elements 44a, 44b, 44c, and 45.

The table top 12 further includes a tray or cutting board 50 on the side of the table opposite the HOB 42. As shown in FIG. 4, the cutting board 50 has an upper planar surface and is removable from the table 10. The tray or cutting board 50 can be supported to be part of the table top 12 in any desirable way. For example, the cutting board 10 may sit inside and on a portion of a frame 20. The supporting surface, not shown, for the cutting board 50 may extend across and span the entire area within the frame. This enables the user to place items on that surface with the cutting board removed. In one embodiment, the removable cutting board 50 is heat and/or bacteria resistant. Further, the removable cutting board 50 may be highly durable and may be made from a high-density polyethylene.

In one arrangement, the table top 12 may be 900 mm (35.4 inches) long and 550 mm (21.7 inches) wide. However, it is recognized that the table top 12 may be of other dimensions and configurations.

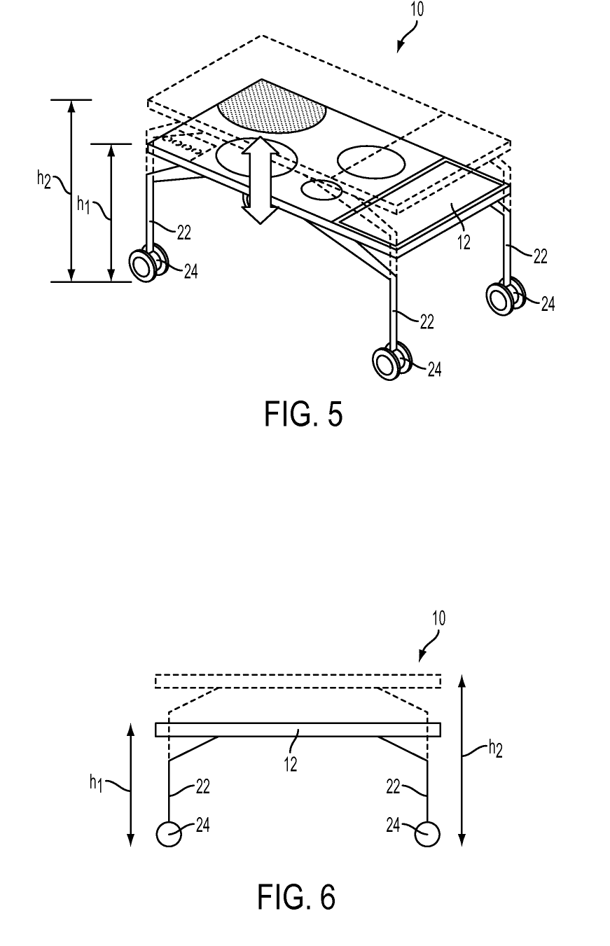

As is evident from FIGS. 5-7, the table 10 is of adjustable height so that the table top 12 can be moved to the desired height for food preparation, food cooking, and for eating regardless of whether the user chooses to eat on a couch, chair, or stool. In one arrangement, the table top 12 is adjustable in height between the range of first height (h1) (shown in solid lines) of 550 mm (21.7 inches) to a second height (h2) (shown in dashed lines) of 800 mm (31.5 inches). Accordingly, the table top 12 is vertically adjustable within a range of 250 mm (9.84 inches) to accommodate different cooking, eating, and serving activities and preferences and can be fully adjusted within that range.

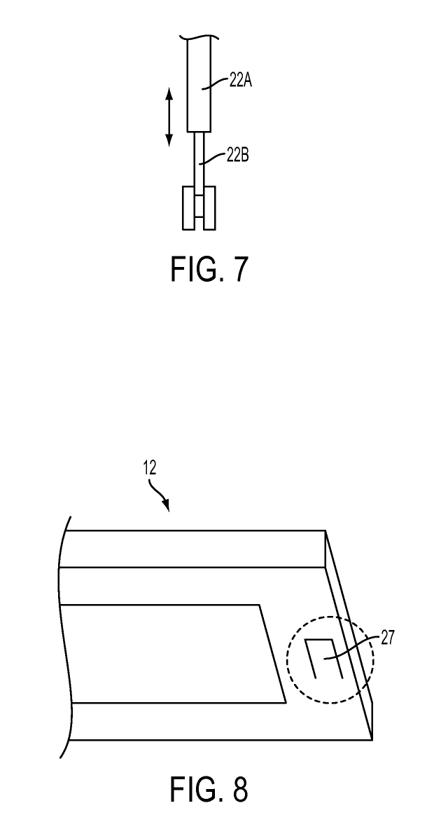

The vertical adjustability of the table top 12 can be provided by any desirable arrangement. In one arrangement, the table 10 includes jacks (not shown) integrated in the legs 22. The jacks may be electrically operable. This arrangement is schematically shown in FIG. 7. In such an arrangement, the legs 22 include an upper portion 22a and a lower portion 22b. The lower portion 22b is telescopically movable relative to upper portion 22a. The jacks cause the effective height of the legs 22 to change, which also causes the height of the table top 12 to change relative to the supporting surface on which the wheels 24 rest. The height adjustability can be controlled by any suitable user-operable switch, such as a toggle switch, operative coupled to the jacks to raise the height of the table top 12. In one arrangement, as schematically shown in FIG. 8, a switch 27 can be provided on the underside of the table top 12 to enable the user to adjust the height of the table and the switch 12 may be a toggle switch.

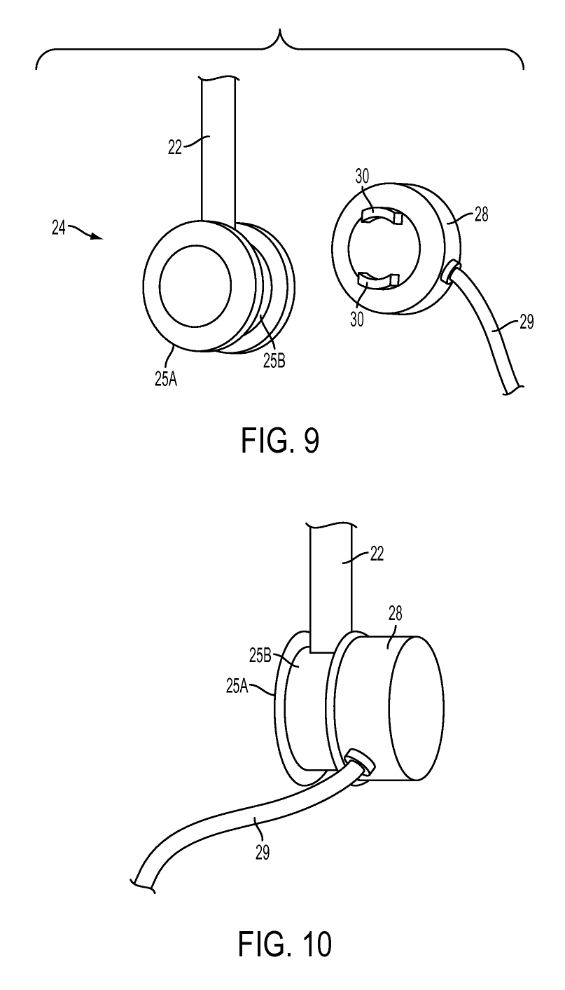

As previously described, the table 10 is connected to an electronic power source by an external power cord 29. More specifically, the power cord 29 may be coupled to one of the wheels 24 of the cooking table 10. Such an arrangement is depicted in FIGS. 9-10. In this arrangement, the wheels 24 include a rotating portion 25a which can roll on a supporting surface, and a stationary portion 25b. As shown, there may also be a rotating portion 25a on the opposite side of the stationary portion 25b.

The end of the power cord 29 is coupled to a plug 28. The plug 28 also includes coupling prongs 30. The exterior of the wheels 24 includes a socket, not shown, with forgiving receptacles that substantially match the shape of the prongs 30. Additionally, a portion the plug 28 is magnetic so as to create a magnetic coupling between the plug 28 and the wheel 24 in lieu of a friction fit coupling of a typical power connection. One advantage of the magnetic coupling between the plug 28 and the wheel 24 is that should a person accidently trip on or pull the wire 29, the plug 28 will easily disconnect from the socket on the wheel 28. This minimizes the possibility of disrupting cooking utensils on the HOB 42 that may be in the process of cooking.

Additionally, when connected, a portion of each of the prongs 30 preferably fits in the stationary portion 25b of the wheel 24 but an extended portion fits into an aligned annular opening in the rotating part of the wheel 25a. This, prevents the rotation of the rotating portion 25a of the wheel 24 relative to the stationary portion 25a, and serves as a wheel lock to keep the cooking table 10 safe.

Accordingly, the mobile cooking table 10 has dimensions, features, and/or characteristics that make it desirable in the interior environment. It is highly adaptive and mobile and becomes an extension of the dinner table, coffee table, desk, etc according to the situation. It also allows the user to cook and eat at the same place, alone or with guests. It also provided the user with more flexibility to eat what they want, when they want, and where they want. It also provided convenience and comfort to enjoy cooking for themselves or their guests. The induction HOB maintains little residual head after the cooking process, so the table top can quickly be converted from a cooking surface to a serving and/or eating surface. The height adjustability enables use of it as an eating surface when the user is sitting on the floor or a chair, and enables the user to use it while standing during food preparation. The power attachment coupling to a wheel provides additional benefits for use in living quarters.

While the present invention has been described with reference to exemplary embodiments, it will be understood by those of ordinary skill in the art that various changes may be made and equivalents may be substituted for elements thereof without departing from the scope of the invention. In addition, many modifications may be made to adapt a particular situation or material to the teachings of the invention without departing from the scope thereof. Therefore, it is intended that the invention not be limited to the particular embodiments disclosed, but that the invention will include all embodiments falling within the scope of the appended claims.

What is claimed is:

1. A mobile cooking table comprising an induction hob and plurality of wheels enabling the mobile cooking table to be rolled on a supporting surface.

2. The mobile cooking table according to claim 1, further comprising a table top raising device enabling the height of the table can be adjusted.

3. The mobile cooking table according to claim 2, further comprising a plurality of telescopic supporting legs, and wherein the bottom of each leg is coupled to a respective wheel.

4. The mobile cooking table according to claim 3, wherein the table top raising device includes an electric jack located in one of said legs configured for vertical adjustment of the table at least 6 inches.

5. The mobile cooking table according to claim 1, further comprising a power coupling positioned at one of the wheels.

6. The mobile cooking table according to claim 2, wherein the power coupling includes a magnetic socket.

7. The mobile cooking table according to claim 1, further comprising a food warming area.

8. The mobile cooking table according to claim 1, further comprising one of a removable cutting board or a removable tray.

9. The mobile cooking table according to claim 8, wherein said one of a removable cutting board or a removable tray is substantially coplanar with a cooking surface of the induction hob.

10. The mobile cooking table according to claim 9, further comprising a plurality of telescopic supporting legs, and wherein the bottom of each leg is coupled to a respective wheel, and a magnetic power coupling positioned at one of the wheels.

11. A mobile cooking table comprising: a cooking device having a substantially planar cooking surface, a frame including a plurality of wheels, and a power coupling located on at least one of said wheels, and wherein the power coupling, when connected, serves to lock said one of the wheels.

12. The mobile cooking table according to claim 11, wherein the power coupling also forms a magnetic coupling.

13. The mobile cooking table according to claim 12, wherein the power coupling, when connected, serves to lock said one of the wheels.

14. The mobile cooking table according to claim 11, further comprising a food warming area on the planar cooking surface.

15. The mobile cooking table according to claim 11, further comprising a removable cutting board being substantially coplanar with the cooking surface.

16. The mobile cooking table according to claim 11, further comprising a removable tray being substantially coplanar with the cooking surface.

17. The mobile cooking table according to claim 11, further comprising a plurality of height-adjustable telescopic supporting legs, and wherein the bottom of each leg is coupled to a respective wheel of the plurality of said wheels.

18. The mobile cooking table according to claim 17, further comprising an electric jack coupled to one of said plurality of legs.

19. The cooking table according to claim 18, wherein the cooking surface is part of a height-adjustable table top, and further comprising a switch on the bottom of the table top for controlling the electric jack to raise and lower the table top.

20. A mobile cooking table comprising:
a table top including at least an induction hob and one of a removable cutting board or a removable tray;
a base having a plurality of telescopic legs,
a wheel mounted at the bottom of each of said plurality of telescopic legs; and
a magnetic power coupling on at least one of said plurality of wheels.
